(19) United States
(12) Patent Application Publication
(10) Pub. No.: US 2008/0246185 A1
(43) Pub. Date: Oct. 9, 2008

(54) COMPOSITION OF LED FRAME BODY AND MANUFACTURING METHOD THEREOF

(76) Inventors: Bily Wang, Hsin Chu (TW); Jonnie Chuang, Hsin Chu (TW); Chia-Hung Chen, Hsin Chu (TW)

Correspondence Address: HDSL, 4331 STEVENS BATTLE LANE, FAIRFAX, VA, 22033, US

(21) Appl. No.: 11/696,216

(22) Filed: Apr. 4, 2007

(51) Int. Cl. C08L 63/00; C08K 3/08

(52) U.S. Cl. 264/320; 523/442; 524/440

(57) ABSTRACT

A lamp body is an enclosing structure that encloses a blue light-emitting crystal to form a LED structure. In a method of manufacturing frame body of the LED, resin, titanium, and fluorescent powder are mixed uniformly to constitute a composition of frame body, then the composing materials being placed into a mould for processing a thermally pressing procedure to thus form a frame body. By the blue light emitted from the blue light-emitting crystal, the fluorescent powder of the frame body may be excited to emit uniform yellow light, which may be further mixed with the blue light to become white light.

### BACKGROUND OF THE INVENTION

1. Field of the Invention

The present invention generally relates to a light emitting diode (LED) technique, in particular, to a manufacturing technique of the frame body of LED.

2. Description of Prior Art

Accordingly, light emitting diode (LED) can only be applied in the field of indicating lamp in early days because of the lack of lightness. However, its application is expanded comprehensively in recent days with the promising illumination market of the future due to the improvement of technique and the continuous promotion of lighting lightness, for example traffic light, search light, flash light, and the backlight source of liquid crystal display (LED).

However, since made of semiconductors and composed of different materials, LED can emit lights of different colors, such as red, blue, green, yellow, and white, wherein the white LED is most notable due to its capability of replacing traditional lamps.

In the white light LED 100 of the prior arts, as shown in FIG. 1, a blue light-emitting crystal 105 arranged upon a holder 103 is electrically connected to the holder via two conducting wires 107, 108, and thus an electrically conducting path is formed. In the meantime, a yellow fluorescent layer 104 is coated upon the blue light-emitting crystal 105, while a frame body 101 and a bottom seat 102 are fixed at two sides of the holder 103 correspondingly for enclosing the blue light-emitting crystal 105. On the other hand, a window 106 is opened on the top side of the frame body 101 for the passing of light. When being electrically conducted, the blue light-emitting crystal 105 generates blue light, which will further excite fluorescent layer 104 to generate yellow light. By means of the combination of both blue light and yellow light, a white light is generated. However, in terms of frame body 101, it can only reflect the blue light that is emitted by the blue light-emitting crystal 105, which can not generate yellow light via the frame body 101, so it is impossible for the white light LED 100 to generate purely white light without a phenomenon of blue preference, making the white light LED 100 unable to develop an optimally lighting effectiveness. Therefore, via the improved material of frame body, how to improve the phenomenon of blue preference possessed by LED in the lighting process has become a problem needed to be urgently solved by the relative industry.

### SUMMARY OF THE INVENTION

Regarding aforementioned drawbacks, the present invention is to provide a composition of the frame body of a LED and a manufacturing method thereof for improving the phenomenon of blue preference possessed by LED in the lighting process.

For achieving the objective, the present invention provides a composition of the frame body of a LED and a manufacturing method thereof, wherein the lamp body is an enclosing structure that encloses a blue light-emitting crystal to form a LED structure. In the method of manufacturing frame body according to the present invention, resin (EPOXY or silicon), titanium, and fluorescent powder are mixed uniformly to constitute a composition of frame body, then the composing materials being placed into a mould for processing a thermally pressing procedure to thus form a frame body. By the blue light emitted from the blue light-emitting crystal, the fluorescent powder of the frame body may be excited to emit uniform yellow light, which may be further mixed with the blue light to become white light.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a structural illustration of the LED according to the prior arts;

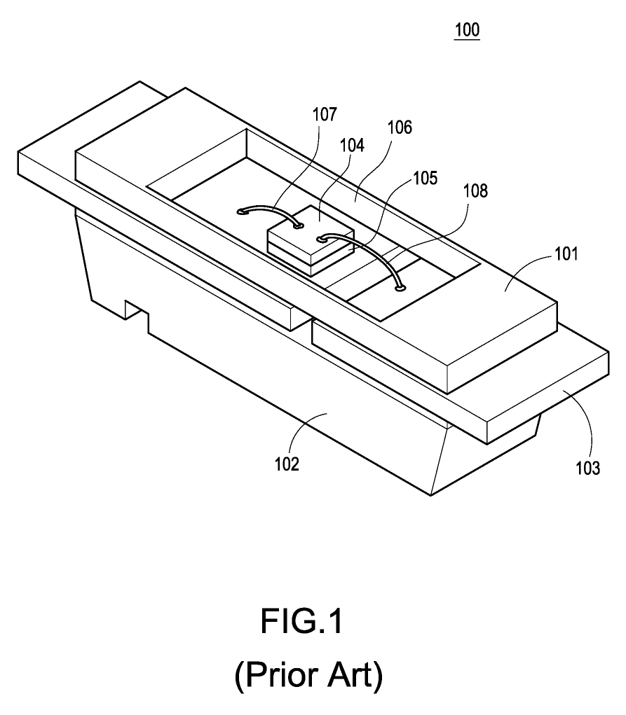

FIG. 2 is a manufacturing flow chart of the fame body of LED according to the present invention.

### DETAILED DESCRIPTION OF THE INVENTION

In cooperation with attached drawings, the technical contents and detailed description of the present invention will be as follows.

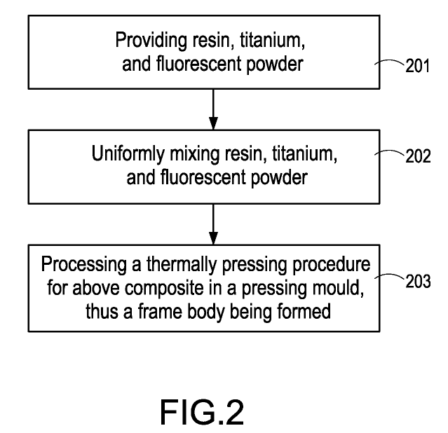

Please refer to FIG. 2, which illustrates a manufacturing flow chart for a LED's frame body, which is an enclosing structure arranged around a LED. In step 201, resin (EPOXY or silicon), titanium, and fluorescent powder (yellow color is preferred) are provided, wherein the preferably mixing proportion of resin, titanium, and fluorescent powder is approximately 100:10:1˜1:1:1. In step 202, the resin, titanium, and fluorescent powder are uniformly mixed to form a composition, which is then placed into a mould for process a thermally pressing procedure, and thus a frame body is formed, as shown in step 202.

According to the manufacturing flow chart shown in FIG. 2, the LED's frame body is an enclosing structure that contains fluorescent powder and encloses a blue light-emitting crystal. When the blue light-emitting crystal emits blue light, it not only can excite yellow light from the fluorescent layer arranged at top side, but also can generate yellow light excited from the fluorescent powder in the frame body in any direction surrounding the blue light-emitting crystal. Therefore, in the interior of frame body, yellow light may be excited by the blue light emitted from the blue light-emitting crystal in any direction and be mixed with blue light to become white light without emitting any blue light that is not mixed with yellow light. Thereby, the blue light and the yellow light may be maintained at a fixed proportion, and thus it may reduce the occurrence of the phenomenon of blue preference in the lighting colors of white light.

Aforementioned description is only preferable embodiment according to the present invention, being not used to limit its executing scope. Any equivalent variation and modification made according to appended claims is all covered by the claims claimed by the present invention.

What is claimed is:

1. A composition of LED frame body, comprising of resin, titanium, and fluorescent powder, the composing proportion of which is approximately 100:10:1˜1:1:1.

2. The composition of LED frame body according to claim 1, wherein the color of the fluorescent powder is yellow.

3. The composition of LED frame body according to claim 1, wherein the resin is one of EPOXY and silicon.

4. A manufacturing method of LED frame body, the frame body being an enclosing structure, which is used for enclosing a LED, and the method comprising:
a) providing resin, titanium, and fluorescent powder;
b) uniformly mixing the resin, the titanium, and the fluorescent powder, thus a composite being formed; and
c) processing a thermally pressing procedure for the composite in a pressing mould, thus a frame body being formed.

5. The manufacturing method of LED frame body according to claim 4, wherein the color of the fluorescent powder is yellow.

6. The manufacturing method of LED frame body according to claim 4, wherein the resin is one of EPOXY and silicon.
